(19) United States
(12) Patent Application Publication
(10) Pub. No.: US 2008/0047402 A1
(43) Pub. Date: Feb. 28, 2008

(54) Socket adapter for ratchet wrench or torque wrench

(75) Inventor: Shu-Wen Lin, Taichung (TW)

Correspondence Address: BIRCH STEWART KOLASCH & BIRCH, PO BOX 747, FALLS CHURCH, VA, 22040-0747, US

(73) Assignee: Forging Adapter Co., Ltd.

(21) Appl. No.: 11/510,592

(22) Filed: Aug. 28, 2006

(51) Int. Cl. B25G 1/00; B25B 23/16

(52) U.S. Cl. 81/177.85

(57) ABSTRACT

A socket adapter for a ratchet wrench or a torque wrench that has plural ribs and rib spaces comprises:
a hexahedral engaging portion, having a plurality of vertices and edges, further comprising an aperture positioned on the surface of an annular groove;
a socket attached to the bottom of the hexahedral engaging portion;
a metal elastic wire accommodated along the groove of said hexahedral engaging portion and encircling said interior wall and the metal elastic wire having an open end and a hook portion at the other end to grapple said aperture and further having at least a portion projecting from the surface of the hexahedral engaging portion.

### BACKGROUND OF THE INVENTION

1. Technical Field

The present invention relates to a socket adapter for a ratchet wrench or a torque wrench, and the disclosed socket adapter comprises a hexahedral engaging portion to be engaged with a ratchet of a ratchet wrench, wherein the hexahedral engaging portion has an annular groove where a metal elastic wire fits and wherein by means of the metal elastic wire, a three point fastening system is formed between the socket adapter and the ratchet to facilitate fastening.

2. Description of Related Art

A conventional socket adapter 10 is depicted in FIGS. 1 and 2 which comprises a hexahedral engaging portion 11 and a socket 12 attached to the bottom end thereof.

An annular groove 13 is provided on the out surface of the hexahedral engaging portion 11 and accommodates a metal elastic wire 30 therein. Said metal elastic wire 30 is formed through bending a one-piece metal stick into a non-closed ringlike shape comprising a first elastic section 31, a first bend 32, a second elastic section 33, a second bend 34, a third elastic section 35, a third bend 36 and a fourth elastic section 37 sequentially. Further, the first elastic section 31, second elastic section 33, third elastic section 35 and fourth elastic section 37 of the metal elastic wire 30 contact closely with the groove surface 131 while the first bend 32, second bend 34 and third bend 36 radially protrude from the non-adjacent three edges 112 of the hexahedral engaging portion 11.

However, since the metal elastic wire 30 in the prior art is elastically fit for but not fixed in the groove 13 of the hexahedral engaging portion 11, the bends 32, 34, 36 are not stationary but shiftable. Thus, when such conventional socket adapter 10 is assembled with a ratchet wrench or a torque wrench, the metal elastic wire 30 may shift under the press and revolving force from the wrench and that in turn renders the bends 32, 34, 36 leaving their preset positions and being improperly deformed by the pushing force from the ribs of the ratchet. Consequently, the metal elastic wire 30 would lose its resilience and finally fail to secure the socket adapter 10 with the ratchet.

FIGS. 3 and 4 illustrate another conventional socket adapter 10 having an annular groove 13 and an O-shaped rubber ring 38 straps the surface 131 of the groove 13. When the socket adapter 10 is assembled with a ratchet wrench or a torque wrench, the O-shaped rubber ring 38 is pressed centripetally by the ribs of the wrench and then bounces to retain the hexahedral engaging portion 11 among the ribs of the wrench. Nevertheless, the O-shaped rubber ring 38 may be not durable and easily damaged through repeated use.

### SUMMARY OF THE INVENTION

The present invention has been accomplished under the circumstances in view and provides an improved securing construction of a socket adapter for a ratchet wrench or a torque wrench that has plural ribs spaced by plural intervals. The disclosed socket adapter comprises:

a hexahedral engaging portion, having a plurality of vertices and edges, further comprising an annular groove with an aperture on the groove surface thereof;

a socket attached to the bottom of the hexahedral engaging portion; and

a metal elastic wire fitting the groove of the hexahedral engaging portion with a open end and a hook portion at the other end to clasp said aperture, and further having at least a portion projecting from the surface of the hexahedral engaging portion.

It is one object of the present invention to provide a socket adapter for a ratchet wrench or a torque wrench that the metal elastic wire thereof is stably positioned by not only fitting the groove of the hexahedral engaging portion but also clasping the aperture on the groove surface to avoid sliding along the groove so that the first and second bends thereof can be invariably retained at the preset positions to ensure the fastening effect.

It is another object of the present invention to provide a socket adapter that can be assembled or disassemble with a ratchet wrench or a torque wrench easily by reason of the elastic flexibility of the metal elastic wire thereon. Since the metal wire has its open end freely extendable while the hook portion at the other end clasping said aperture, the same is therefore flexible to facilitate assembling and disassembling works smooth and effort-saving.

It is still another object of the present invention to provide a socket adapter that can be safely fastened to a ratchet wrench or a torque wrench under the effect of a three-point fastening system regarding to the first bend, second bend and the edge of the hexahedral engaging portion where a relevant resultant forces acts on.

A further object of the present invention is to provide a socket adapter with the metal elastic wire being easily formalized. The accurate measures such as the length and radian of the first, second and third elastic section and the bending angle of the first and second bends can be decided by taking the hook portion of the metal wire as a datum point; according to the periphery of said groove surface and the vertices as well as the edge length of the hexahedral engaging portion and the rib as well as rib intervals of the wrench. Once the specifications and conditions regarding said parts are verified, the metal elastic wire can be made accurately.

A further object of the present invention is to provide a socket adapter that the aperture thereof is positioned corresponding to one of the vertices of the hexahedral engaging portion. Thereby, the open end of the third elastic portion of the metal wire thereof can be consequently defined as a bent hook portion to fit the aperture. Under such definition, the constructing of the metal wire can be simplified.

Yet a further object of the present invention is to provide a socket adapter that comprises a socket attached to the bottom of the hexahedral engaging portion wherein the socket has a hexahedral hole formed inward and a retaining portion radially intrusive over the hexahedral hole. Thereby, the socket adapter of the present invention may allow a long screw bolt to pass therethrough and contact a nut screwed at the bottom of the bolt to facilitate operation.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is an exploded view of a conventional socket adapter with a metal elastic wire.

FIG. 2 is a cross sectional transverse view of a conventional socket adapter with a metal elastic wire.

FIG. 3 is an exploded view of a conventional socket adapter with an O-shaped rubber ring.

FIG. 4 is a cross sectional transverse view of a conventional socket adapter with an O-shaped rubber ring.

FIG. 5 is an exploded view of the socket adapter with a metal elastic wire according to the present invention.

FIG. 6 is a cross sectional transverse view of the socket adapter with a metal elastic wire according to the present invention.

FIG. 7 is a perspective view of the socket adapter with a metal elastic wire according to the present invention.

FIG. 8 is a sectional view taken along Line 8-8 of FIG. 7.

FIG. 9 is a perspective showing relativity between the disclosed socket adapter and a ratchet wrench.

FIG. 10 is a plane view showing the disclosed socket adapter combined with a ratchet wrench.

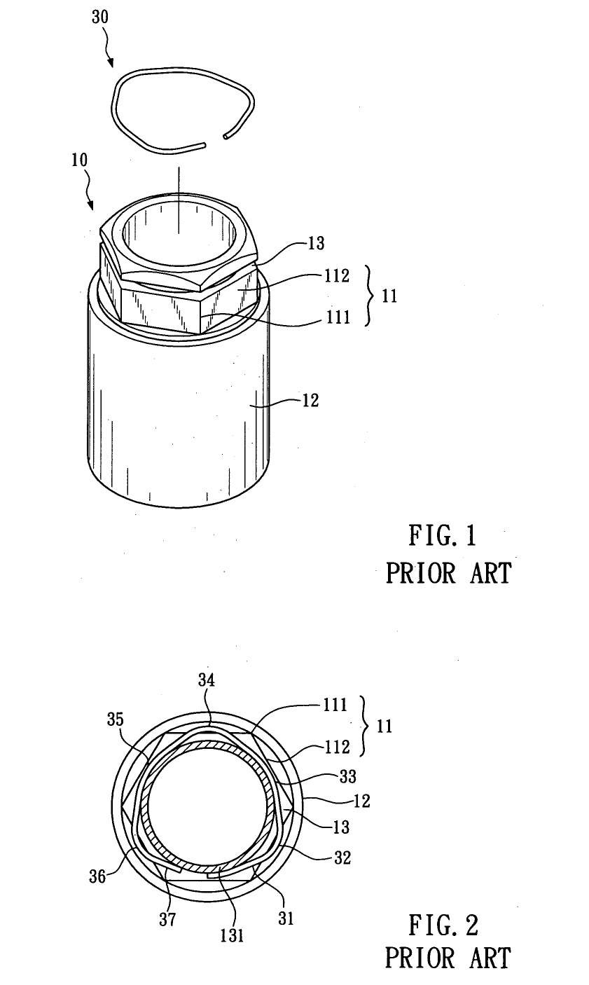

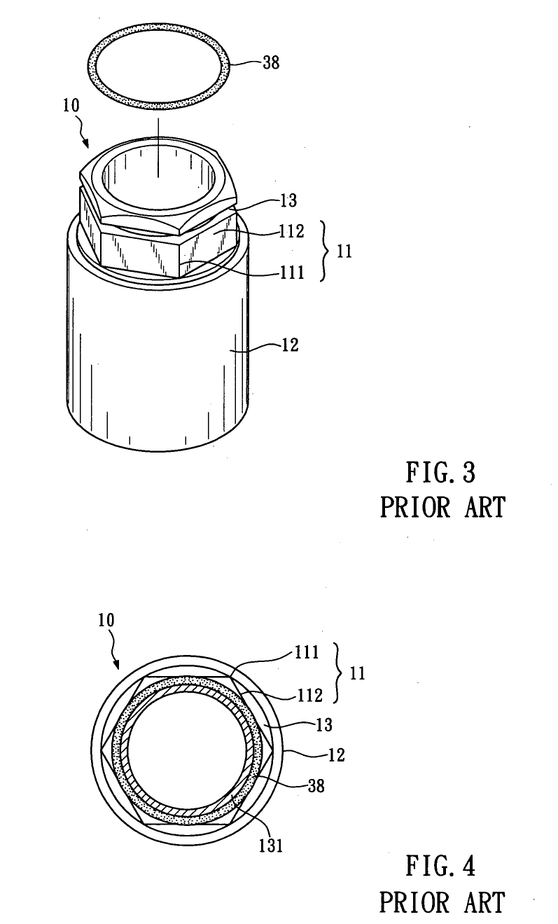

### DETAILED DESCRIPTION OF THE PREFERRED EMBODIMENT

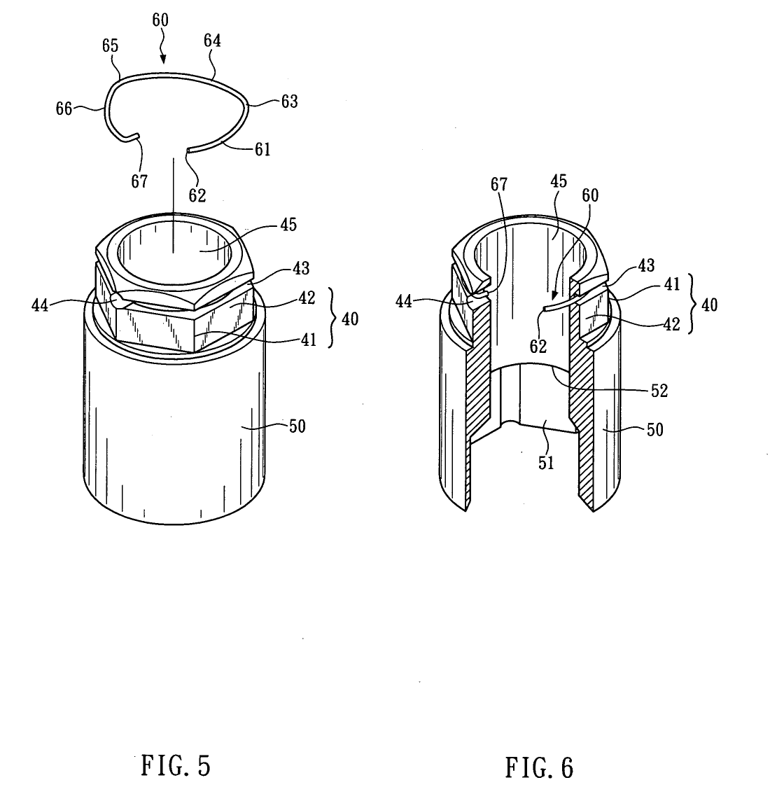

As shown in FIGS. 5 and 6, the socket adapter for a ratchet wrench or a torque wrench according to the present invention primarily comprises:

a hexahedral engaging portion 40, having six vertices 41 and six edges 42, and further comprising an annular groove 43 with an aperture 44 on the groove surface 431; wherein the aperture 44 is provided corresponding to one of the vertices 41 of the hexahedral engaging portion 40; and a socket 50 attached to the bottom of the hexahedral engaging portion 40, interiorly having a hexahedral hole 51, a retaining edge 52 around the top end of the hexahedral hole 51 and a round hole 45 inside the hexahedral engaging portion 40 led to said hexahedral hole 51; and

a metal elastic wire 60 accommodated in the groove 43 of said hexahedral engaging portion 40 which comprises a first elastic section 61 with an open end 62 and connected to a second elastic section 64 through a first bend 63 and the second elastic section 64 further connected to a third elastic section 66 through a second bend 65 and the end of the third elastic section 66 formed as a hook portion 67.

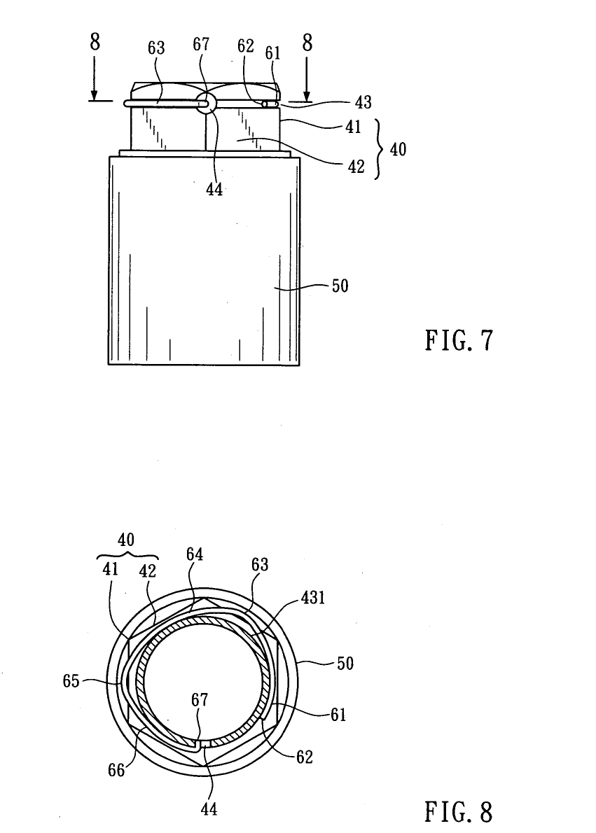

Referring to FIGS. 7 and 8, the metal elastic wire 60 is seen in the groove 43 of said hexahedral engaging portion 40 with the hook portion 67 grappling said aperture 44, and the first, second as well as third elastic sections 61, 64, 66 contacting closely with the surface 431 of the groove 43 under a centripetal pressure while the first and second bends 63, 65 respectively projecting from two of the edges 42 of the hexahedral engaging portion 40.

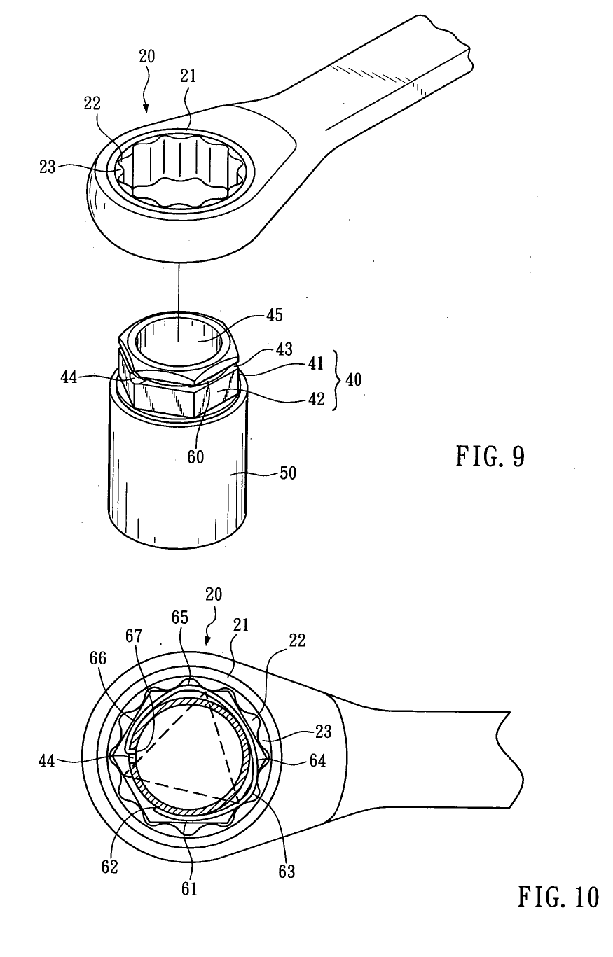

In FIGS. 9 and 10, the hexahedral engaging portion 40 of the present invention is now assembled with the ratchet 21 of a ratchet wrench 20 and the vertices of the hexahedral engaging portion 40 are respectively engaged in the rib intervals 22. At that point, the first bend 63 and second bend 65 of the metal wire 60 storage the deformation energy during being inlayed in the rib intervals 22 and then reposition to press against the ribs 23 so as to form two fastening points. Thus, the mutual thrusts between the bend 63, 65 and the ribs 23 of the wrench causes the second elastic section 64 to press on the surface 431 of the groove 43. Thus, the hexahedral engaging portion 40 receives a lateral thrust parallel to a radial direction, so that where the hexahedral engaging portion 40 receives the thrust, it is further pressed against the rib 23 to form a third fastening point. These three fastening points are indicated by the vertices of the dotted triangle in FIG. 10. As a result, the hexahedral engaging portion 40 compresses the ribs 23 at the edge where a resultant force of said two thrusts acts on and form a three-point fastening system to fixedly fasten the socket adapter to the ratchet 21 of the wrench 20.

By means of the described structure, the disclosed metal wire 60 is stably positioned by not only fitting the groove of the hexahedral engaging portion 40 but also clasping the aperture 44, to avoid sliding along the groove 43. Therefore, the first and second bends 63, 65 thereof may permanently respectively project from non-adjacent two edges of the hexahedral engaging portion 40 without shift. Even under repeated assembling or disassembling the hexahedral engaging portion 40 with the wrench 20, the relative positions of the bends 63, 65 of the metal wire 60 against the hexahedral engaging portion 40 can keep constant.

The disclosed metal wire 60 is designed to fit the groove of the hexahedral engaging portion 40 and grasp the aperture 44 so that one end thereof is fixed while the other end is freely extendable to facilitate assembling or disassembling the hexahedral engaging portion 40 with the ratchet 21. For instance, during assembling the hexahedral engaging portion 40 with the ratchet 20 of a wrench 21, the ribs 23 of the ratchet 20 compress the metal wire 60, and this conducts the open end 62 thereof moving toward the hook portion 67 at the fixed end for a predetermined distance. Buffing of said predetermined distance permits the bends 63, 65 radially moving toward the core of the hexahedral engaging portion 40 but not circularly shifting along the grove 43. Thereupon, the deformation of the metal wire 60 can be accurately controlled as radial contract to ensure the hexahedral engaging portion 40 being sleeved by the ratchet 21 smooth.

As said metal elastic wire 60 is elastically extendable, it permits a user to assemble the hexahedral engaging portion 40 with a ratchet wrench or a torque wrench easily and vice versa.

The disclosed metal elastic wire 60 is easily formalized with accurate measures such as the length and radian of the first, second and third elastic sections 61, 64, 66 and the bending angle of the first and second bends 63, 65 by taking the hook portion 67 of the metal wire 60 as a datum point; according to the periphery of said groove surface 431 and the vertices 41 as well as the edge 42 length of the hexahedral engaging portion 40 and the rib 23 as well as rib intervals 22 of the wrench. Once the specifications and conditions regarding said parts are verified, the metal elastic wire can be made accurately with less error rate.

The aperture 44 is positioned corresponding to one of the vertices 41 of the hexahedral engaging portion 40. Thereby, the end of the third elastic portion 66 of the metal wire 60 can be consequently defined as a bent hook portion 67 to fit the aperture 44. Under such definition, the constructing of the metal wire 60 can be simplified. Through the experiments conducted by the inventor, it is learned that an aperture 44 not positioned corresponding to one of the vertices 41 renders the Euclidean distance between the open end 62 and hook portion 67 excessively short or long and this in turn undesirably affects the elastic flexibility of the metal elastic wire 60. Thus, the inventor has the conclusion that the most preferable position of the aperture 44 to be arranged is about one of the vertices 41 of the hexahedral engaging portion 40.

A socket 50 is attached to the bottom of the hexahedral engaging portion 40, which has a hexahedral hole 51 formed inward, a retaining portion 52 radially intrusive over the hexahedral hole 51. The hexahedral engaging portion 40 further has a round hole 45 axially passing therethrough and led to said hexahedral hole 51. Thereby, the socket adapter of the present invention may allow a long screw bolt to pass therethrough and contact a nut screwed at the bottom of the bolt to facilitate operation.

Although a particular embodiment of the invention has been described in detail for purposes of illustration, it will be understood by one of ordinary skill in the art that numerous variations will be possible to the disclosed embodiments without going outside the scope of the invention as disclosed in the claims.

1. A socket adapter for a ratchet wrench or a torque wrench that has plural ribs and rib intervals, comprising:
a hexahedral engaging portion, having six vertices and six edges, further comprising an annular groove with an aperture positioned at a groove surface;
a socket attached to the bottom of the hexahedral engaging portion;
a metal elastic wire accommodated in the groove of said hexahedral engaging portion and contacting closely with the groove surface, which has an open end and a hook portion at the other end to grapple said aperture and further has at least a portion projecting from the surface of the hexahedral engaging portion.

2. The socket adapter as claimed in claim 1, wherein the metal elastic wire is formed by bending a one-piece metal stick into the shape comprising successively a first elastic section adjacent to said open end, a first bend, a second elastic section, a second bend, and a third elastic section adjacent to said hook portion.

3. The socket adapter as claimed in claim 2, wherein the first bend and second bend protrude from two of the edges of the hexahedral engaging portion.

4. The socket adapter as claimed in claim 2, wherein the first elastic section, second elastic section respectively have at least part thereof closely contacted with the groove surface of said groove.

5. The socket adapter as claimed in claim 1, wherein the aperture is aligned with one of the vertices of the hexahedral engaging portion.

6. The socket adapter as claimed in claim 2, wherein the interior angle of the first and second bends are slightly greater than the included angle between each two adjacent ribs, of the rachet wrench or the torque wrench that the socket adapter is to be assembled with.

7. (canceled)

8. The socket adapter as claimed in claim 1 wherein the socket interiorly has a hexahedral hole and a retaining edge over the top end thereof and further a round hole axially runs through the hexahedral engaging portion and led to said hexahedral hole.

9. A combination of a socket adapter and a wrench, comprising:
a ratchet wrench or a torque wrench having plural ribs and plural rib intervals;
a socket adapter comprising:
a hexahedral engaging portion, having six vertices and six edges, further comprising an annular groove with an aperture positioned at a groove surface;
a socket attached to the bottom of the hexahedral engaging portion;
a metal elastic wire accommodated in the groove of said hexahedral engaging portion and contacting closely with the groove surface, which has an open end and a hook portion at the other end to grapple said aperture and further has at least a portion projecting from a surface of the hexahedral engaging portion;
wherein the metal elastic wire is formed by bending a one-piece metal stick into the shape comprising successively a first elastic section adjacent to said open end, a first bend, a second elastic section, a second bend, and a third elastic section adjacent to said hook portion;
wherein when the hexahedral engaging portion is assembled with a ratchet wrench or a torque wrench, the vertices of the hexahedral engaging portion are respectively engaged in the rib intervals, and simultaneously, a three-point fastening system is formed between the socket adapter and the ratchet wheel of the wrench, wherein the three-point fastening system is regarding the bends of the metal elastic wire and an edge of a hexahedral engaging portion where a relevant resultant forces acts on.
